(19) United States
(12) Patent Application Publication
(10) Pub. No.: US 2026/0190279 A1
(43) Pub. Date: Jul. 2, 2026

(54) NEUTRAL-FORMING TRANSFORMER THERMAL MANAGEMENT

(71) Applicant: FORD GLOBAL TECHNOLOGIES, LLC, Dearborn, MI (US)

(72) Inventors: Haider Mhiesan, Canton, MI (US); Benjamin Kulhawik, Chelsea, MI (US); Kirk Pulay, Belleville, MI (US); Timothy Harris, Grosse Ile, MI (US)

(21) Appl. No.: 19/336,985

(22) Filed: Sep. 23, 2025

Related U.S. Application Data
(60) Provisional application No. 63/739,980, filed on Dec. 30, 2024.

(51) Int. Cl. H05K 7/20

(52) U.S. Cl. CPC H05K 7/20209; H05K 7/20172

(57) ABSTRACT

A thermal management system for a neutral-forming transformer (NFT) includes a duct path with a fan, a damper, and inlet and outlet valves that direct airflow between the NFT and an auxiliary device. Sensors detect NFT temperature, NFT current imbalance, and auxiliary device temperature. A controller operates the fan and positions the damper to provide cooling of the NFT, bypass the NFT, or distribute airflow to both the NFT and the auxiliary device. The fan operates at multiple speeds and in forward or reverse directions. The damper positions include directing airflow exclusively to one region or splitting airflow between regions. Control is based on absolute values or rates of change of sensed conditions. When the auxiliary device temperature is below a cold-start value, the valves close and the fan deactivates to retain heat for passive heating.

### CROSS-REFERENCE TO RELATED APPLICATION

This application claims the benefit of U.S. provisional application Ser. No. 63/739,980, filed Dec. 30, 2024, the disclosure of which is hereby incorporated in its entirety by reference herein.

### TECHNICAL FIELD

This disclosure relates to energy systems, and more particularly to managing thermal conditions within electrical equipment.

### BACKGROUND

A home energy system may integrate multiple energy resources and electrical components to provide power to a residence. Such systems can include transformers, inverters, batteries, and other devices that interact with utility power or operate independently during outages. Operation of these systems can involve managing thermal conditions.

### SUMMARY

A thermal management system includes a neutral-forming transformer (NFT) positioned within a duct flow path, one or more sensors that sense the NFT temperature and a current imbalance associated with the NFT, a fan that drives airflow through the duct, and a damper positionable to direct or inhibit airflow toward the NFT. A controller operates the fan and damper based on the sensed conditions, including adjusting fan speed across multiple levels and selecting damper positions to optimize cooling or bypass the NFT. In some embodiments, control actions occur when either or both of the NFT temperature and current imbalance exceed defined values, or when a rate of change in those parameters is detected. The damper may also move to an intermediate position to distribute airflow between the NFT and a second region, such as one housing a battery or other auxiliary device. In certain scenarios, inlet and outlet valves may be selectively closed to retain heat within the second region when the auxiliary component temperature falls below a defined value, thereby enabling passive heating of that region.

A ventilation system includes a housing with an airflow network having an intake duct, an exhaust duct, a first chamber housing the neutral-forming transformer (NFT), a second chamber separate from the first chamber, and a junction that fluidly couples the intake duct to both chambers. A fan drives airflow through the network, while a damper at the junction moves among positions to either split airflow between the chambers, restrict airflow to the first chamber, or restrict airflow to the second chamber. A controller operates the fan and adjusts the damper position in response to a thermal condition associated with the first chamber. In some embodiments, the fan is located within the intake duct between the junction and the network inlet. The fan may also employ a variable-speed motor capable of forward and reverse operation to provide an adjustable flow rate. The system can additionally include inlet and outlet valves movable between open and closed positions to control airflow into and out of the housing, with the controller operating these valves in coordination with fan operation and damper adjustment. One or more temperature sensors may be placed within the first chamber, and the controller can use input from the sensors to determine fan operation and damper positioning.

A method involves operating a fan to drive airflow through a duct path that extends across a neutral-forming transformer (NFT) and an auxiliary device. The method includes adjusting the position of a damper to direct airflow toward the NFT when either the NFT temperature rises above a defined temperature value or a current imbalance across the NFT exceeds a set imbalance value. When neither the NFT temperature nor the imbalance exceed their respective values, and an auxiliary device temperature rises above its value, the damper instead directs airflow toward the auxiliary device and away from the NFT. In some cases, the damper may direct airflow to both the NFT and the auxiliary device when both components exceed their temperature values, or block airflow to the auxiliary device entirely when the NFT temperature and imbalance both exceed their values. The method may also include coordinated control of fan speed and damper position according to multiple airflow response modes based on combinations of NFT temperature and imbalance. Additionally, when the auxiliary device temperature falls below a cold-start value, the inlet and outlet valves of the duct path may be closed and the fan deactivated, placing the system into a passive heating state.

### BRIEF DESCRIPTION OF THE DRAWINGS

FIG. 1 is a schematic diagram of an example home energy system including a neutral-forming transformer (NFT), a home energy management system (HEMS) controller, and various distributed energy resources (DERs) such as an electric vehicle.

FIG. 2 is a schematic diagram of an example ventilation system enclosure with a neutral-forming transformer (NFT) and an auxiliary component housed in separate chambers, showing a damper in a neutral position directing airflow to both chambers.

FIG. 3 is a schematic diagram of the ventilation system enclosure of FIG. 2, showing the damper in a position directing airflow exclusively to the auxiliary component chamber while restricting flow to the NFT chamber.

FIG. 4 is a schematic diagram of the ventilation system enclosure of FIG. 2, showing the damper in a position directing airflow exclusively to the NFT chamber while restricting flow to the auxiliary component chamber.

FIG. 5 is a schematic diagram of the ventilation system enclosure of FIG. 2, showing a passive heating mode in which inlet and outlet valves are closed and the fan is deactivated to retain heat around the auxiliary component.

FIG. 6 is a flowchart illustrating a method of operating a thermal management system that includes selectively directing airflow toward a neutral-forming transformer (NFT), an auxiliary component, or both, based on monitored thermal and electrical operating conditions.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Residential energy systems may include electrical infrastructure for supplying power to a variety of loads within a home or similar structure. In many installations, these systems are configured to support both 240V and 120V loads. Examples of such loads include heating and cooling equipment, lighting, appliances, and personal electronics. A 240V supply may be provided across two conductors (commonly referred to as L1 and L2), and 120V operation may be supported through use of a neutral reference positioned between these conductors (e.g., a grounded center tap of a utility distribution transformer).

In certain residential or mobile environments, a dedicated neutral conductor may not be present. Such a condition may arise, for example, in systems operating in backup or off-grid modes, or in installations where power is supplied by sources that do not provide a grounded center tap, such as certain generators, electric vehicles, or standalone inverters. Similar conditions may be present in retrofit or modular deployments where full utility infrastructure is unavailable or intentionally bypassed. In these environments, the absence of a neutral reference may limit the system's ability to support 120V loads, which typically rely on a stable voltage midpoint between the L1 and L2 conductors.

To accommodate 120V load operation in systems without a dedicated neutral conductor, a neutral-forming transformer (NFT) may be utilized. The NFT includes windings configured to generate a reference point between the L1 and L2 conductors, effectively establishing a local neutral. This arrangement allows 120V and 240V loads to be supported concurrently using the same L1 and L2 supply conductors. The NFT may be installed within or proximate to a residential distribution panel and may support one or more branch circuits connected across the derived neutral and either of the supply conductors. In some implementations, the NFT operates in cooperation with a controller configured to monitor transformer behavior and manage loads in response to transformer operating conditions.

The NFT may operate as part of a home energy management system (HEMS). A HEMS may include one or more controllers, sensors, switching elements, and software routines coupled to grid connection points, local energy sources, and household loads. Power may be supplied from the grid, a generator, a bidirectional electric vehicle interface, a photovoltaic system, or any combination thereof. While the NFT itself is typically not a power source, it may be electrically coupled to such sources and may remain configured to establish a neutral reference across varying modes of operation. The HEMS may evaluate electrical conditions and influence system behavior to maintain compatibility with load types that rely on the NFT-derived neutral.

In some implementations, the NFT may be subject to current imbalance conditions arising from the manner in which electrical loads are distributed across a split-phase system. For example, certain household loads (such as lighting, outlets, or electronics) may be coupled between a single phase conductor and the neutral reference, rather than across both phase conductors. If the current drawn from one of the phase conductors exceeds that of the other, the resulting imbalance may induce transformer behavior that deviates from idealized conditions. These imbalances may occur intermittently or persist during extended periods of operation, particularly in configurations where 240V loads are absent, limited in number, or selectively disabled.

When operated under imbalanced loading conditions, the NFT may experience elevated internal temperatures associated with asymmetrical magnetic flux or localized resistive heating. This thermal behavior may vary depending on load magnitude, phase skew, and duration. In some environments, particularly those with compact installation envelopes or limited ventilation pathways, the accumulation of heat within or around the NFT may place constraints on overall system design. For example, sustained operation at elevated temperature may influence how other components of the HEMS are packaged or positioned relative to the NFT.

One common approach to addressing this condition is to oversize the NFT; i.e., to select a transformer with a larger thermal mass or higher continuous power rating than would otherwise be necessary under balanced conditions. While this approach may provide a degree of thermal margin, it introduces tradeoffs related to physical size, materials, and installation complexity that may be impractical or inconsistent with broader design priorities.

Accordingly, there is interest in system-level architectures that can provide more refined management of NFT thermal behavior. In particular, it may be desirable to implement a targeted cooling arrangement that operates in response to transformer-specific conditions such as imbalance, temperature rise, or duty cycle. Such an arrangement may allow the NFT to remain compact and thermally stable even during extended operation. In some cases, this approach may further support modular integration within a HEMS, in which the NFT and associated thermal management elements are co-located with switching devices, sensors, and other control components.

The present disclosure describes a thermal management system for an NFT used in a HEMS or similar environment. In some embodiments, the system includes a housing that surrounds the NFT and a power source to define a thermally isolated region, and a ventilation duct system within the housing that facilitates airflow through the housing. A fan is dynamically operable to facilitate airflow across one or both of the NFT and the power source. Additional control elements, such as dampers or flow-directing passages, may be incorporated to selectively manage airflow paths within the enclosure. The system may operate in coordination with a controller to initiate or adjust cooling behavior in response to transformer conditions, without requiring changes to the underlying transformer structure.

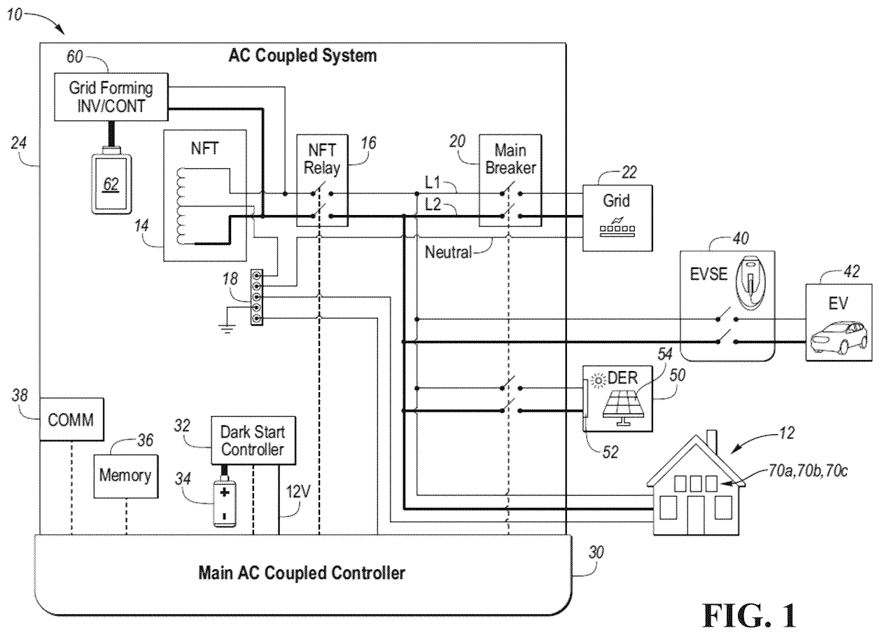

FIG. 1 illustrates an example implementation of a home energy system 10 configured to monitor and influence electrical behavior across multiple conductors supplying power to household loads. The system 10 may include power-handling infrastructure for distributing electrical energy throughout a building structure such as a residential home 12 and coordinating its flow among connected elements. In some configurations, the system 10 includes busbars, circuit protection devices, and interface terminals coupled to conductors supplying 120V and 240V branch circuits. The system 10 includes a neutral-forming transformer (NFT) 14 monitored by a controller 30 that initiates control actions based on transformer operating conditions, such as current, temperature, or voltage characteristics.

The home energy system 10 receives power from grid 22 and electrically interfaces with various local energy sources and loads. The grid 22 may deliver a split-phase 240V supply across two conductors, typically referred to as L1 and L2, with a grounded neutral center tap in conventional configurations. In the illustrated implementation, grid 22 provides a bidirectional interface with the system 10 such that energy may be delivered to or exported from the premises. In some implementations, energy delivered by the grid 22 is routed through a main breaker 20 and distributed via L1 and L2 conductors within the system 10. Loads coupled to these conductors may include devices requiring 240V across L1 and L2, or 120V between either conductor and a derived neutral.

The main breaker 20 may serve as a primary disconnect device, permitting selective isolation of the home 12 from the grid 22. When closed, the main breaker 20 allows grid-supplied power to flow to loads, distributed energy resources (DERs), or storage elements within the system. During grid outages or intentional off-grid operation, the main breaker 20 may be opened to prevent backfeed or to enable islanded operation. The status of the main breaker 20 may also be used as an input to the controller 30, informing control logic related to transformer usage, load prioritization, or DER coordination.

The NFT 14 is electrically coupled between the L1 and L2 conductors and includes windings arranged to generate a neutral reference used for supporting 120V loads within the home 12. The presence of NFT 14 within the home energy system 10 enables compatibility with load types that rely on a neutral reference, particularly in installations where no utility-provided neutral is available. This may be relevant in backup power modes, mobile environments, or systems supplied by sources such as inverters or electric vehicles.

In the illustrated configuration, NFT 14 is installed downstream of an NFT relay 16. The NFT relay 16 is configured to selectively connect or disconnect conductors, such as the L1 and L2 lines feeding the NFT 14 or associated loads. The NFT relay 16 may be used to isolate the NFT 14 in response to detected operating conditions or to redirect power flows based on system logic. In some cases, the NFT relay 16 may be a solid-state device, mechanical contactor, or hybrid unit configured to respond to control signals.

A DER 50 may be electrically coupled to the home energy system 10 to supply or influence power flow within the residential environment. The DER 50 may take a variety of forms, including a solar photovoltaic (PV) system, a battery energy storage system (BESS), an engine generator, a fuel cell, a microturbine, or a bidirectional electric vehicle interface. In the illustrated implementation, a PV system includes a PV inverter 52 and a PV array 54. The PV inverter 52 may be configured to convert DC output from the PV array 54 into AC power for use within the system 10, and may be coupled to the AC bus 18 at a common coupling point.

In some system configurations, the DER 50 may operate in parallel with the grid 22, or may supply power to local loads during grid-disconnected conditions. DER output may vary dynamically based on generation or dispatch conditions and may contribute to current flow across the NFT 14. In some implementations, the controller 30 may monitor DER output directly (such as by sampling power output from the PV inverter 52 or evaluating power quality parameters at the coupling point) to determine whether DER activity contributes to transformer loading or asymmetry between the L1 and L2 conductors. Information from the DER 50 may be used in conjunction with transformer monitoring to identify load shifts, voltage imbalance, or other operational states requiring responsive action.

An electric vehicle (EV) 42 and associated electric vehicle supply equipment (EVSE) 40 may be connected to the home energy system 10 and participate in local power management activities. The EVSE 40 may support bidirectional power exchange, allowing the EV 42 to either consume or supply power based on system demands. Thus, in some implementations, the EV 42 and associated EVSE 40 may serve not only as a load during charging operations, but also as a DER 50 capable of supplying power to the home 12. For example, a bidirectional EVSE 40 may enable vehicle-to-home (V2H) functionality, in which electrical power is supplied from an onboard vehicle battery to support residential loads during grid outages or other operating conditions, and/or vehicle-to-grid (V2G) functionality, in which power is delivered from the vehicle to the utility grid 22.

The EV 42 and EVSE 40 may influence NFT 14 behavior by affecting aggregate electrical load, current symmetry, or voltage conditions. High-power charging or discharging events may elevate transformer current or thermal load, and changes in charging direction or intensity may introduce dynamic loading characteristics. The controller 30 may monitor the EV/EVSE interface to assess these effects in real time and incorporate this information into transformer oversight routines. Parameters such as charging state, power direction, and conductor-specific current levels may be evaluated alongside other transformer metrics to determine appropriate system responses. The controller 30 may coordinate EV operation with NFT 14 loading conditions, for example by delaying or modulating charging behavior during high-load conditions, or by initiating vehicle discharge to offset asymmetrical loads or transformer stress.

The home energy system 10 includes a Home Energy Management System (HEMS) 24. The HEMS 24 (also referred to as a “HEMS hub 24” or “combiner box”) acts as an integration and coordination point for external and local energy resources and includes various control, sensing, and switching components configured to evaluate electrical conditions and influence system behavior. Components of the HEMS 24 may be housed within a common enclosure or housing that may be weatherproof, thermally managed, or segmented to separate high-voltage and low-voltage compartments. The HEMS 24 includes pass-through or grommeted cable routing for accommodating L1, L2, Neutral, and ground conductors, along with low-voltage wiring for battery connections, control signals, and communications. Internally, the combiner box may include terminal blocks, busbars, relays, fuses, or printed circuit boards configured to support interconnection and coordination of the components within the system 10. In some embodiments, the HEMS 24 further includes circuitry for monitoring voltage and frequency conditions on the AC bus 18. The integration of sensors, relays, and processing logic within HEMS hub 24 provides a localized environment for responsive decision-making and coordinated system oversight.

The controller 30 of the HEMS 24, also referred to herein as “HEMS controller 30,” serves as a central coordination unit for relays, power sensing, load distribution, transformer performance, grid interaction, and general energy flow management. The HEMS controller 30 is configured to coordinate operation of the system 10 based on measured electrical conditions and predefined control logic. The HEMS controller 30 may include processing hardware, memory, and associated software or firmware instructions enabling it to execute logic routines, reference stored action tables, and initiate control responses. These responses may include controlling relays, influencing load distribution, initiating NFT isolation, or communicating with other system components such as DERs or vehicle charging interfaces. The HEMS controller 30 may monitor parameters such as transformer temperature, current draw, and voltage drop, either directly or through associated sensors, and may determine whether one or more predefined values, thresholds, or combinations of conditions are met.

While the HEMS controller 30 is illustrated as being integrated within the HEMS hub 24, in other implementations, the controller 30 may be positioned elsewhere within the home 12 or may be remote from the premises altogether. For example, certain aspects of the control logic may be executed by a cloud-based platform, with the controller 30 operating as a distributed control system that coordinates local measurements and actions with remote decision-making resources. This flexibility allows the control functions associated with NFT monitoring and load coordination to be implemented using a variety of hardware topologies, including configurations with centralized, decentralized, or hybrid control architectures.

The HEMS controller 30 may include processing hardware configured to operate in conjunction with a memory 36 storing logic routines, parameter values or thresholds, and other control instructions. The memory 36 may comprise a non-transitory computer-readable medium storing instructions that, when executed by the controller 30, cause it to perform the control and coordination operations described herein. These operations may include initiating transformer isolation, influencing load distribution, or controlling relays based on measured electrical conditions.

The memory 36 may reside locally within the same housing as the controller 30, such as within the HEMS hub 24, or may be located remotely and accessed via wired or wireless communication. In some implementations, the memory 36 may be cloud-accessible, enabling updates to control logic or threshold values over time. Regardless of location, the memory 36 provides the programmable basis for the system's decision-making capabilities. In this way, upon determining one or more predefined values, thresholds, or combinations of conditions are satisfied, the controller 30 may initiate actions stored in the memory 36.

The HEMS 24 may serve as a central signaling and control hub, interfacing with other components in system 10 as well as external or remote entities. More particularly, HEMS controller 30 may include or be operatively coupled to a communication interface 38 configured to enable data exchange between the controller 30 and other system components. For example, the controller 30 may be communicatively connected to the EVSE 40 or DER 50 to receive operational status, power availability, or charging readiness signals. In embodiments where vehicle state of charge (SOC) data is made available to the system 10, the HEMS 24 may receive such information from the EVSE 40 and determine whether to enable or delay charging. The HEMS 24 may also coordinate energy flow logic by activating or deactivating system relays in response to changing DER output, vehicle connection status, or homeowner-specified operating modes.

The communication interface 38 may support wired or wireless communication protocols, and may be used to receive updated control logic, action tables, or firmware updates from a cloud-based service. In some implementations, the interface 38 also facilitates interaction with a mobile application or utility server. In configurations supporting cloud-based functionality, the communication interface 38 may maintain a data link between the HEMS controller 30 and a remote server environment. This connectivity may allow operational data, such as transformer loading trends, control actions taken, or threshold event histories, to be uploaded for long-term storage, analytics, or diagnostic purposes. In some cases, the cloud platform may support system updates, allowing the controller 30 to receive revised logic structures or updated firmware.

To support resilience during outages or interruptions, the home energy system 10 may include a dark start controller 32 for managing a dark start battery 34 to provide power to control circuits when grid voltage is absent. The system 10 may further include a grid-forming inverter 60 electrically coupled to a power source 62. The inverter 60 may supply AC power to conductors within the AC coupled system 10 when grid 22 is unavailable or insufficient. These components may enable continued operation of the system 10 in non-grid scenarios, allowing the NFT 14 to remain active and loads to be supplied from backup power when needed.

The home energy system 10 is configured to supply electrical power to a variety of loads (e.g., loads 70a, 70b, and 70c) connected across the L1 and L2 conductors. These loads may represent residential appliances, lighting circuits, heating and cooling equipment, personal electronics, or other devices requiring either 120V or 240V operation. Some loads may be connected line-to-line across L1 and L2 to receive 240V service, while others may draw 120V between either L1 or L2 and the neutral reference established by the NFT 14.

The electrical behavior of a residential energy system is inherently dynamic, shaped by patterns of user activity, environmental variation, and fluctuating energy supply. Loads may cycle rapidly, remain energized for extended periods, or vary unpredictably depending on usage habits and system configuration. In environments with L1 and L2 conductors supplying both 120V and 240V loads, current may become unbalanced as different loads activate on separate legs. The NFT 14, which establishes a neutral reference between these conductors, may experience increased magnetic and thermal stress when supporting asymmetric load conditions. Such stress may be especially pronounced during sustained imbalance, high-current operation, or a combination thereof.

Additional complexity may arise from the presence of distributed energy resources (DERs) 50, including photovoltaic systems, generators, or bidirectional electric vehicle interfaces. These sources may operate intermittently or introduce variable output levels that influence the voltage, current, or balance across L1 and L2 conductors. In some cases, DER contribution may amplify transformer loading or introduce asymmetries that affect the performance and thermal state of the NFT 14. Moreover, residential systems may evolve over time, incorporating new appliances, replacing existing devices, or integrating modular or retrofit components without full coordination. These changes can shift power demand characteristics and deviate from original design assumptions, introducing electrical patterns that impose additional demands on the transformer.

In addition to electrical dynamics, the thermal and physical environment surrounding the NFT 14 may influence its operational behavior. Factors such as ambient temperature, enclosure ventilation, and installation proximity to heat-generating components can affect the transformer's ability to dissipate heat. For example, an NFT 14 installed in a low ventilation panel or in an exterior cabinet exposed to direct sunlight may exhibit higher baseline operating temperatures than one located in a temperature-controlled interior space. Physical installation variables such as conductor gauge, terminal torque, or enclosure spacing may also affect current-handling capacity or thermal performance. Because these conditions may not be reflected in static system specifications, the HEMS controller 30 may rely on real-time temperature measurements and adaptive logic to evaluate transformer performance.

In some implementations, individual loads may be associated with control or sensing elements that enable their behavior to be influenced or monitored. For example, certain loads may be equipped with controllable interfaces (such as smart switches, circuit-level relays, or programmable outlets) that permit the HEMS controller 30 to initiate load modification in response to transformer stress or imbalance. Additionally, current or voltage sensors positioned along the L1 and L2 branches may provide real-time information on load behavior, which can inform logic-based control decisions. Although the specific load types and arrangements may vary, the system 10 is generally configured to identify, evaluate, and influence load activity to preserve transformer stability and extend operational viability in environments lacking a utility-supplied neutral.

To assess transformer behavior and identify potential operating concerns, the system 10 may include one or more sensing elements positioned within the HEMS hub 24 or in proximity to the NFT 14. These elements may be configured to measure transformer winding temperature, current draw along the L1 and L2 conductors, and voltage characteristics across NFT terminals. In some implementations, temperature sensors such as thermistors or resistance temperature detectors are placed near transformer windings or within the enclosure to provide representative thermal data under both transient and sustained load conditions. Current sensors, such as current transformers, may be installed upstream or downstream of the NFT 14 to measure conductor flow independently, enabling evaluation of load balance across L1 and L2. Voltage sensing may include direct measurements of terminal values or calculated drops across winding inputs and outputs, with persistent deviations used to indicate elevated impedance or emerging electrical degradation. These parameters may be monitored individually or in combination to detect compound electrical stress, asymmetry, or trends in thermal accumulation.

The controller 30 receives measurement data from these sensing elements and processes the information in accordance with predefined logic routines or action tables. The information may be processed locally within the HEMS hub 24 or transmitted to a remote processing environment. Current measurements may be normalized relative to the NFT's rated load capacity to support threshold-based comparisons as a percentage of expected values. Similarly, temperature data may be filtered or time-averaged to distinguish short-duration fluctuations from sustained heating conditions that warrant intervention. Voltage analysis may be used to confirm the presence of a stable AC signal or to detect signs of system imbalance or transformer degradation. By analyzing real-time electrical behavior, including load asymmetry, excessive current draw, or thermal rise, the controller 30 may determine whether transformer operating conditions fall within acceptable limits. When predefined thresholds are exceeded or abnormal conditions persist, the system 10 may initiate appropriate control responses such as load shaping, NFT isolation, or other corrective actions.

While the controller-based monitoring and response routines described above may help manage thermal stresses within the home energy system 10, physical characteristics of the system's environment can present additional challenges. In many residential settings, the NFT 14 operates within a constrained installation envelope that may limit airflow or restrict passive heat dissipation. Over time, as real-world load behavior fluctuates and DER contributions shift, the thermal profile of the NFT 14 can vary significantly. In some cases, heat may accumulate faster than it can be dissipated, particularly during extended periods of high or asymmetric loading. Even when control responses such as load curtailment or NFT isolation are implemented, underlying thermal mass and enclosure effects may delay temperature recovery, allowing heat to persist or build.

Although system-level logic can influence the electrical stress experienced by the NFT 14, it does not directly address the physical pathways through which heat exits the system. As such, control-based mitigation alone may prove insufficient in certain environments, such as compact utility closets, sealed wall cavities, or integrated product enclosures. In addition, implementation of modular or retrofit HEMS architectures may introduce variability in housing design, ducting layout, and environmental exposure. Accordingly, it may be beneficial to supplement system logic with structural elements designed to promote active and passive thermal flow.

To that end, the home energy system 10 may incorporate a thermal management assembly or system 100 that directs airflow across selected components of the system 10. This thermal management system 100 may include a set of internal duct pathways and flow control features for routing ambient air over an NFT 104 and an auxiliary device such as a power source 106 housed within a common enclosure 102. Depending on operating conditions, airflow may be actively driven by a fan 160 or directed along separate internal pathways using a flow control damper 164. In some implementations, this system 100 supports dynamic reconfiguration of airflow to cool either or both of the internal chambers based on transformer heating, load conditions, or startup requirements. In certain modes, the system may inhibit flow entirely to facilitate targeted heating of the power source 106 using residual NFT heat.

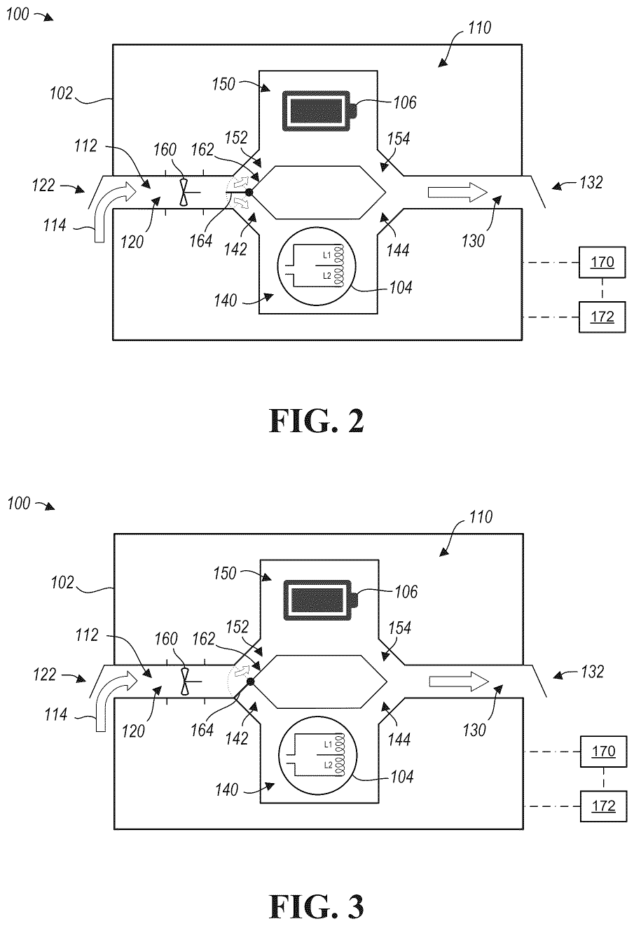

The structural configuration of this thermal management system 100 is illustrated in FIG. 2. As shown, the enclosure 102 defines an internal duct system 110 having a flow junction 162 and separate chamber pathways associated with the NFT 104 and the power source 106.

The NFT 104 may correspond to the NFT 14 described previously in connection with FIG. 1. As discussed above, the NFT 104 is coupled between the L1 and L2 conductors of the home energy system 10 and is configured to generate a derived neutral reference point to support operation of both 240V and 120V loads. In this role, the NFT 104 establishes a local midpoint voltage that allows conventional 120V branch circuits to operate even in the absence of a utility-supplied neutral. The NFT 104 may operate under a range of load conditions and electrical configurations, including grid-connected, off-grid, or DER-powered scenarios involving generators, photovoltaic systems, or bidirectional electric vehicles.

Within the thermal management system 100, the NFT 104 is positioned inside the enclosure 102, and more specifically, within a transformer chamber 140 defined by the duct system 110. The transformer chamber 140 is fluidly coupled to various ducts (e.g., transformer chamber inlet 142 and transformer chamber outlet 144), valves, and airflow controls to allow directed thermal management based on transformer heating behavior. Because the NFT 104 carries a substantial portion of load current and may be subject to persistent or asymmetric current flow, it is a considerable contributor to internal system heating. Accordingly, thermal management system 100 includes features for selectively directing airflow over the NFT 104 and evaluating transformer conditions through temperature and current sensing.

The thermal management system 100 further includes an auxiliary device, which may comprise a power source 106 or another component of the HEMS 24 that benefits from temperature-based airflow control. While the illustrated embodiment depicts the auxiliary device as a power source 106 positioned within a dedicated chamber of the ventilation housing, other implementations may include battery systems, power electronics, or ancillary HEMS components requiring targeted airflow during certain operational conditions, such as charging, load transitions, or temperature-sensitive operation.

The power source 106 may comprise one or more battery cells or modules configured to deliver DC power, and may optionally include internal electronics such as a battery management system (BMS), protection circuitry, or state-of-charge monitoring elements. While typically not a primary load or source of heat within the system, the power source 106 may benefit from thermal conditioning to support optimal operation across a range of environmental conditions.

In some embodiments, the power source 106 may correspond to the dark start battery 34 of FIG. 1, which supplies backup power to initiate operation of certain HEMS components during a grid outage. As described above, the dark start battery may provide power to activate the controller 30, energize the HEMS inverter 32, or facilitate operation of associated DERs or communication interfaces.

Structurally, the power source 106 is enclosed within an auxiliary chamber 150, which is at least partially defined by an auxiliary chamber inlet 152 and an auxiliary chamber outlet 154. These airflow boundaries enable heated or ambient air to be routed into and out of the chamber 150 depending on system state and controller logic. The proximity of the power source 106 to the NFT 104 allows for dynamic thermal interaction between the two components. In some scenarios, when the NFT 104 is energized and operating at elevated temperatures, the system 100 may leverage residual heat from the NFT chamber 140 to warm the power source 106. This may be particularly useful in colder environments, where preheating of the battery enhances response or charging behavior.

In the illustrated configuration, one or more sensors 172 may be positioned within or adjacent to the enclosure 102 to detect operating conditions associated with the NFT 104, the power source 106, or both. These sensors 172 may include temperature sensors such as thermistors or resistance temperature detectors (RTDs) thermally coupled to the NFT windings or battery casing, allowing transformer and battery temperatures to be monitored in real time. Additional sensors may include current sensors positioned along conductors coupled to the NFT 104 or power source 106, as well as voltage monitoring elements configured to detect fluctuations in AC or DC characteristics. In some embodiments, sensor signals may be time-averaged or filtered to evaluate transient events versus sustained thermal or electrical loading.

Sensor outputs may be received by a controller 170 configured to monitor and interpret NFT 104 and power source 106 behavior. In some embodiments, the controller 170 may correspond to or be associated with the controller 30 discussed with respect to system 10 of FIG. 1. In other implementations, the controller 170 may be a dedicated module integrated with the thermal management system 100, configured to evaluate sensor signals and implement localized control responses. By analyzing current, voltage, and temperature data from the sensors 172, the controller 170 can assess whether the NFT 104 or power source 106 is operating within acceptable parameters or exhibiting thermal trends that may warrant corrective action. As will be discussed, control responses may include activation of airflow mechanisms or adjustment of airflow routing within the enclosure 102.

The thermal management system 100 includes an enclosure 102 that houses certain electrical components of the home energy system 10, including the NFT 104 and the power source 106. As shown in FIG. 2, enclosure 102 provides a dedicated structural housing for these components and may be positioned within or adjacent to the HEMS hub 24 illustrated in FIG. 1. In this context, the NFT 104 and power source 106 may correspond to the NFT 14 and dark start battery 34 introduced earlier, now shown as being co-located in a common housing.

The sensors 172 and controller 170 may be incorporated within the enclosure 102, positioned to monitor the NFT 104 and power source 106 directly. For example, temperature sensors may be mounted to internal walls of the enclosure or thermally coupled to specific component surfaces. In other embodiments, the sensors 172 and controller 170 may reside outside of the enclosure 102. For instance, the controller 170 may be implemented as part of a centralized control architecture within the HEMS hub 24 of FIG. 1, with sensor wiring routed through the enclosure to allow remote condition monitoring. In still other cases, sensor circuitry may be split between internal and external locations, with select sensors integrated into component housings and others positioned along exterior conductor paths or structural panels.

Enclosure 102 may define a generally box-shaped housing formed from thermally insulative materials that inhibit heat transfer between internal components and ambient surroundings. Suitable materials may include molded polymers, fiberglass-reinforced composites, or multi-layered panels incorporating insulative foam or air gap structures. These materials may be selected for their ability to retain internal heat when beneficial (e.g., for warming the power source 106) or resist external heat ingress when active cooling is desired. In the illustrated implementation, the interior of the enclosure is divided into at least two functional chambers: a transformer chamber 140 that houses the NFT 104, and an auxiliary chamber 150 that contains the power source 106. These chambers 140, 150 may be defined by internal walls or partitions that guide airflow and structurally isolate each component.

In addition to thermal insulation, the enclosure 102 may provide electrical isolation from the surrounding environment. For example, the housing material may be electrically non-conductive or coated to prevent contact with energized conductors, thereby reducing the potential for electrical faults or unintentional exposure. In some configurations, the enclosure may also be sealed to protect internal components from environmental contaminants such as dust, debris, or moisture.

The enclosure 102 may also include mechanical features to support installation and service. For example, mounting brackets, cable routing paths, or removable access panels may be incorporated to accommodate system assembly and maintenance. The enclosure may be designed for wall-mounted, shelf-mounted, or floor-standing deployment, and may support modular integration with other HEMS infrastructure. In retrofit applications, the compact form factor and electrical isolation characteristics may allow the enclosure 102 to be installed in proximity to existing panels or electrical pathways without extensive rework.

The thermal management system 100 includes a duct system 110 configured to route air within enclosure 102 for thermal management of internal components. As shown in FIG. 2, the duct system 110 defines an airflow path 112 that extends from an external air source through internal routing structures and exits back to the environment. In general, airflow path 112 originates at ambient air 114, passes through intake and exhaust structures, and may be selectively directed toward either or both of the NFT 104 and the power source 106. In certain embodiments, portions of duct system 110 defining the airflow path 112 may be formed from thermally conductive materials selected to absorb and dissipate heat from adjacent transformer components.

An intake duct 120 forms the entry section of the duct system 110 and includes an inlet vent 122 that provides an opening through which ambient air 114 may enter the enclosure 102. In some implementations, inlet vent 122 may be shielded or recessed to reduce the likelihood of foreign object ingress or moisture exposure, particularly when the enclosure 102 is installed in partially sheltered or semi-outdoor locations. Positioned along or within the intake duct 120 is an inlet valve 124 (shown in FIG. 5), which may be configured as a controllable damper or flap element. Inlet valve 124 may be selectively positioned to admit or restrict incoming airflow, allowing the system to respond to sensed temperature conditions or operating modes. This intake configuration facilitates both active and passive airflow into the enclosure 102.

On the opposite side of the airflow path 112, an exhaust duct 130 provides a corresponding exit structure for internal air. The exhaust duct 130 includes an outlet vent 132, which provides an opening to the external environment and which may also be shielded, and an outlet valve 134 (shown in FIG. 5) positioned along the flow path. Outlet valve 134 may be implemented as a damper, gate, or other airflow control device, allowing the system to control outgoing airflow or create sealed internal conditions when closed. Inlet valve 124 and outlet valve 134 may be operated in coordination to enable controlled ventilation, isolation, or thermal soaking conditions. Furthermore, in some embodiments, one or both of the inlet valve 124 and the outlet valve 134 may include self-sealing features configured to close airflow paths under low-load or low-temperature conditions.

As shown in FIG. 2, the duct system 110 includes internal routing branches that direct airflow to and from component-specific chambers. In particular, the NFT 104 is positioned within an NFT chamber 140 that is accessible via an NFT chamber inlet 142 and an NFT chamber outlet 144. Similarly, the power source 106 is positioned within an auxiliary chamber 150, which is accessible via a power source chamber inlet 152 and outlet 154. Airflow path 112 may be directed through one or both chambers based on internal flow routing mechanisms, enabling heat transfer away from components generating thermal load or toward components requiring temperature elevation.

To manage airflow distribution within the enclosure 102, the thermal management system 100 includes an airflow junction 162 located at an internal branch point of the duct system 110. The airflow junction 162 is associated with an airflow damper 164, which may be mechanically or electrically actuated to direct airflow between the NFT chamber 140 and the auxiliary chamber 150. In one configuration, airflow damper 164 may adopt a central or intermediate position to allow airflow to both branches. In other configurations, the damper may restrict flow to one chamber or the other, providing targeted thermal management based on real-time or preprogrammed control inputs.

A fan 160 is positioned along the intake duct 120 and is configured to draw ambient air 114 into the airflow path 112. Although FIG. 2 illustrates the fan 160 positioned along the intake duct 120, alternative or supplemental configurations may position a fan along the exhaust duct 130 to drive airflow out of the system.

In some configurations, the fan 160 may be implemented as a variable-speed or speed-controlled device configured to modulate airflow based on real-time operating conditions within the enclosure 102. Rather than operating at a fixed speed or in an on/off manner, fan 160 may be controlled by the controller 170 to dynamically adjust airflow intensity according to detected electrical or thermal parameters. This adaptive fan control enables the thermal management system 100 to respond appropriately to evolving transformer or battery behavior. The speed-controlled fan 160 may be positioned at the intake side of the enclosure 102, as shown, or may instead be located at the exhaust side of the enclosure in alternative embodiments. In either configuration, the fan 160 may be configured to force air into or draw air through the internal duct system 110 to establish or modulate the airflow path 112. In some cases, the fan 160 may be bidirectional or reversible, allowing controller 170 to direct airflow in a selected direction depending on cooling demand or system configuration.

One input to fan speed control logic may be electrical asymmetry across conductors L1 and L2, which can lead to uneven magnetic loading of the NFT 104 and corresponding increases in winding temperature. Sensors 172 positioned within the HEMS hub 24 or in proximity to the transformer terminals may detect this imbalance by independently measuring current along each conductor path. If the difference in measured current exceeds a predefined threshold, or if a pattern of asymmetry persists over time, the controller 170 may initiate a corresponding fan response. In some implementations, fan speed may scale proportionally with the degree of imbalance, such that more pronounced asymmetries trigger more aggressive cooling. This load-responsive behavior allows the system to offset thermally stressful conditions associated with asymmetric transformer operation while preserving quieter and lower-power operation during periods of balanced loading.

In addition to current imbalance, controller 170 may also reference absolute temperature measurements to determine whether cooling airflow is warranted. For example, one or more temperature-sensitive sensors 172 may be thermally coupled to the transformer windings or to an interior surface of the enclosure 102, providing temperature feedback indicative of transformer heating under various load conditions. If the measured temperature exceeds a defined value or threshold, the controller 170 may activate the fan 160 or increase its speed to promote active cooling. In some embodiments, temperature-based fan activation may override or supplement imbalance-based control, addressing persistent heating even in the absence of detected asymmetry. In other cases, the controller 170 may use a combined logic approach, applying weighted thresholds or multi-factor evaluation to determine a blended response.

Positioned proximate the airflow junction 162 is an airflow damper 164, which operates to selectively control airflow distribution into the respective NFT chamber 140 and auxiliary chamber 150. The airflow junction 162 defines a bifurcated passage at which airflow may be directed toward either or both of the chamber inlets 142, 152. The damper 164 is configured to move between multiple positions to modulate which inlets receive airflow. In an intermediate or central position, the damper 164 allows airflow to be directed simultaneously into both the NFT chamber inlet 142 and the auxiliary chamber inlet 152. In this position, both airflow branches remain open and unobstructed. In a first shifted position, the damper 164 obstructs the NFT chamber inlet 142 while maintaining an open path to the auxiliary chamber inlet 152, thereby closing off airflow to the NFT chamber 140. In a second shifted position, the damper 164 obstructs the auxiliary chamber inlet 152 while leaving the NFT chamber inlet 142 unobstructed, thereby isolating the auxiliary chamber 150 from incoming airflow. In this manner, the damper 164 serves as a diverter element that can physically isolate airflow paths depending on system configuration or operating condition.

Although referred to as a damper, damper 164 may be implemented using various valve configurations suitable for modulating internal airflow in a compact ducted enclosure. In some embodiments, the damper 164 comprises a pivotable vane or plate that is rotatably positioned within the junction 162 to block or expose airflow passages as described above. Other implementations may use a sliding baffle or segmented flap assembly capable of shifting laterally or angularly to open or close internal flow paths. The damper 164 may be constructed from lightweight, thermally stable materials that withstand repeated actuation and temperature cycling within the enclosure 102. While a single damper is shown and described at the airflow junction 162, equivalent flow control could be achieved using multiple coordinated shutters or directional valves located at or near each chamber inlet.

FIG. 2 illustrates an operational configuration of the thermal management system 100 in which the airflow damper 164 is positioned at an intermediate setting. In this position, airflow may be directed concurrently to both the NFT chamber 140 and the auxiliary chamber 150. As such, FIG. 2 represents a dual-cooling mode in which both the NFT 104 and the power source 106 receive active airflow. This configuration may correspond to a default or steady-state operating mode, where neither component is thermally dormant and both benefit from some degree of cooling support.

Ambient air 114 enters the enclosure 102 through the inlet vent 122, which is open and unobstructed in this operating mode. The inlet valve 124 is also in an open position, allowing incoming air to pass through the intake duct 120. Fan 160 operates to draw or push this ambient air into the duct system 110. At the airflow junction 162, the damper 164 is positioned such that airflow is split between both branch ducts, enabling air to flow toward both internal chambers without obstruction. This permits simultaneous airflow routing through both the NFT path and the auxiliary path.

A first portion of the airflow enters the NFT chamber 140 through the NFT chamber inlet 142, passes across the NFT 104, and exits through the NFT chamber outlet 144. In parallel, a second portion of the airflow enters the auxiliary chamber 150 through the auxiliary chamber inlet 152, passes across the power source 106, and exits through the auxiliary chamber outlet 154. The dual outlet streams rejoin within the exhaust duct 130, pass through the open outlet valve 134, and exit the enclosure via outlet vent 132. The system architecture allows these airflow paths to operate concurrently and without interference, supporting coordinated cooling of both internal components.

This operating configuration may be engaged during routine conditions in which both the NFT 104 and power source 106 are under load or experience moderate temperature rise. For example, during normal power delivery combined with battery charging, both components may exhibit thermal activity warranting airflow. By maintaining the damper 164 at an intermediate position and operating the fan 160, the system can provide baseline thermal management across both chambers. Additional control adaptations may shift the damper position or airflow intensity in response to changing thermal conditions, as discussed further below.

In the configuration shown in FIG. 3, the airflow damper 164 is positioned to direct intake air primarily toward the auxiliary chamber 150. This mode differs from the intermediate configuration of FIG. 2 in that the damper 164 has rotated or translated to a position that substantially blocks the NFT chamber inlet 142. In some implementations, the damper 164 may completely close the NFT chamber inlet 142 to prevent active airflow from entering the NFT chamber 140. In other implementations, a limited or controlled bypass flow may be permitted, for example to reduce pressure buildup or maintain minimal circulation. In either case, the NFT 104 is excluded from the primary airflow path, and the majority of actively driven airflow is routed through the auxiliary chamber 150.

As in prior configurations, ambient air 114 enters the enclosure 102 through the inlet vent 122, which is exposed to the surrounding environment and may include a physical shield to inhibit particulate or moisture intake. The inlet valve 124 remains open, and the fan 160 operates to draw or push air through the intake duct 120. At the airflow junction 162, the repositioned damper 164 blocks airflow to the NFT chamber inlet 142 and opens airflow to the auxiliary chamber inlet 152. As a result, intake air is routed into the auxiliary chamber 150 without diversion.

The intake air flows across the power source 106, facilitating thermal exchange with internal surfaces of the battery or surrounding structures. After traversing the chamber, the air exits via the auxiliary chamber outlet 154 and flows into the exhaust duct 130. From there, the airflow passes through outlet valve 134 and exits the enclosure via outlet vent 132. Because the NFT chamber 140 is bypassed, the temperature within that region may remain relatively stable or increase due to component self-heating, depending on the operational state of the NFT 104.

This configuration may be used during periods in which the power source 106 exhibits elevated thermal demand, such as during rapid charging, sustained discharging, or temperature-sensitive standby conditions. The ability to isolate and actively cool the power source 106 allows the system 100 to preserve battery health and manage thermal stress without overcooling other components. In some cases, the exclusion of the NFT 104 from the airflow path may also facilitate passive heating within the NFT chamber 140, particularly when heating the power source 106 is not desirable or required.

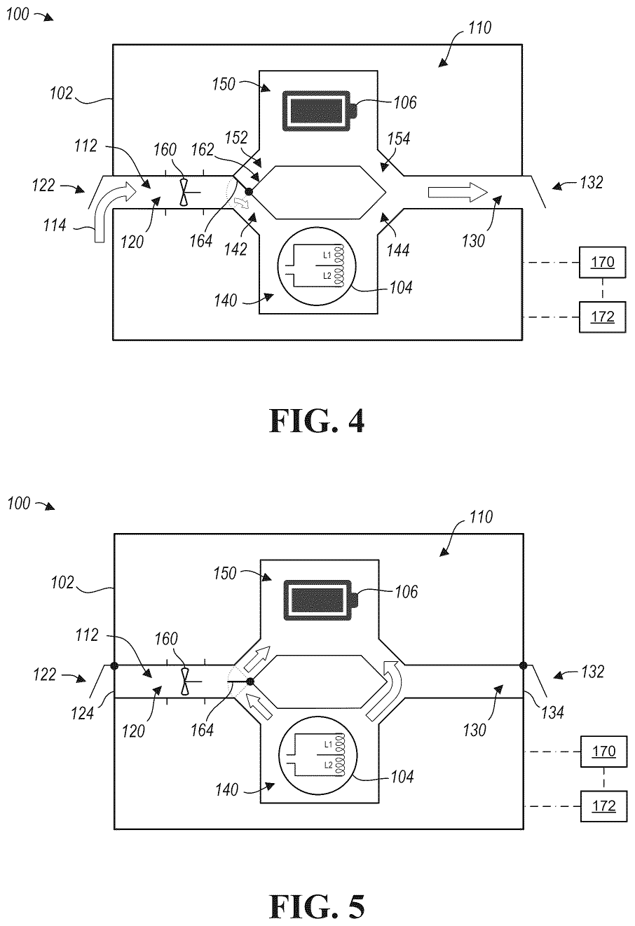

In the configuration of FIG. 4, the airflow damper 164 is positioned to direct airflow solely through the NFT chamber 140. In this configuration, the damper 164 obstructs the auxiliary chamber inlet 152, effectively isolating the power source 106 from the duct system 110. Airflow is instead routed through the NFT chamber inlet 142, permitting intake air to pass over or around the NFT 104 while bypassing the auxiliary chamber 150. This mode of operation enables targeted cooling of the NFT 104 without concurrently affecting the thermal state of the power source 106.

Ambient air 114 enters through the inlet vent 122 and passes the inlet valve 124, which may be selectively open to admit airflow. The fan 160 draws this ambient air through the intake duct 120 and directs it through the NFT chamber inlet 142. Within the NFT chamber 140, the airflow traverses across thermally significant regions of the NFT 104, such as winding surfaces, terminal regions, or structural supports. Warmed air then exits the NFT chamber 140 through the NFT chamber outlet 144 and is conveyed through the exhaust duct 130. The airflow proceeds past the outlet valve 134 and exits the enclosure 102 through the outlet vent 132.

This configuration may be employed during operational periods in which the NFT 104 is subject to elevated thermal load or transient stress, such as periods of unbalanced current flow, sustained high-power operation, or conditions resulting in transformer heating. By excluding the auxiliary chamber 150 from the active airflow path, the system may allow the power source 106 to remain thermally insulated or retain existing heat energy. This may be advantageous during periods when battery heating is unnecessary or when charging or discharge events do not require active cooling.

FIG. 5 illustrates a passive heating configuration of the thermal management system 100, in which airflow through the enclosure 102 is intentionally restricted. In this state, the airflow damper 164 remains in the intermediate position described with reference to FIG. 2, allowing internal duct communication with both the NFT chamber 140 and the auxiliary chamber 150. However, the inlet valve 124 and the outlet valve 134 are both positioned in a closed state, restricting the exchange of ambient air 114 with the interior of the enclosure 102. Additionally, the fan 160 is deactivated, such that no active airflow is generated through the duct system 110. This combination of closed external valves and a stationary fan results in a substantially stagnant internal environment, with limited or no forced ventilation.

In this configuration, thermal energy generated by the NFT 104 during operation may accumulate within the NFT chamber 140 and migrate through the duct system 110. Because the airflow damper 164 allows continued passage to both chambers, a portion of this accumulated heat may naturally migrate into the auxiliary chamber 150 via thermal conduction or low-level convective movement. This internal heat transfer allows the power source 106 to incrementally warm over time without the need for a dedicated heating element or active air circulation. The configuration thereby leverages thermal energy already present within the enclosure 102 to elevate or maintain the temperature of the power source 106 under suitable conditions.

The passive heating configuration shown in FIG. 5 may be used in scenarios where the ambient environment is cold and the battery requires gradual warming before reaching an operational temperature threshold. For example, during early startup conditions in winter climates, the system 100 may remain in this configuration to raise the temperature of the power source 106 using retained heat from the NFT 104. Because neither the fan 160 nor external airflow pathways are active, energy usage and noise generation remain minimal. In some implementations, the controller 170 may place the system 100 into this configuration based on readings from sensors 172 indicating low battery temperature and stable or rising transformer temperature.

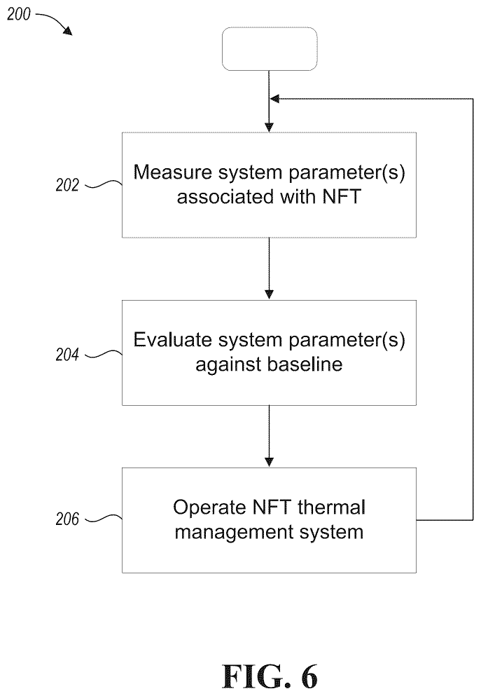

Referring now to FIG. 6, and with continued reference to FIGS. 1-5, a method 200 is illustrated for controlling the operation of the thermal management system 100 described above. As noted, the system includes various structural features that enable directed airflow across different internal components based on operational demands. In addition to these structural capabilities, the system may employ active control logic that dynamically responds to sensed conditions by adjusting airflow parameters such as damper position, fan speed, and valve configuration.

At step 202, the controller 170 initiates a monitoring or measuring phase in which it receives or collects data from one or more sensors 172. These sensors may be positioned within or outside the enclosure 102 and are configured to measure electrical and thermal parameters associated with the NFT 104, power source 106, or surrounding environment. For example, the sensors 172 may include current sensors for the L1 and L2 conductors, temperature sensors positioned near transformer windings or battery terminals, and voltage sensors capable of detecting input/output drop across the NFT 104. In some embodiments, ambient temperature may also be detected to provide additional context for interpreting internal conditions. Sensor readings may be gathered continuously, periodically, or on a triggered basis. The data collected in this monitoring phase may include both real-time measurements and historical or averaged values used for trend analysis or filtering out transient anomalies.

As part of the monitoring phase, the controller 170 may receive temperature data from one or more sensors 172 configured to monitor the operating temperature of the NFT 104. These sensors may be disposed within the NFT chamber 140, in thermal contact with the transformer housing or internal windings, or positioned proximate to heat-generating regions to capture representative temperature data. In some configurations, a thermistor, resistance temperature detector (RTD), or other temperature-sensitive element may be embedded within the structure of the enclosure 102 or secured to mounting brackets supporting the NFT 104. The resulting data may reflect absolute temperature, a rate of temperature change, or localized heating patterns indicative of uneven thermal accumulation. By tracking these thermal measurements over time, the controller 170 can evaluate whether transformer heating remains within operational tolerances or exhibits a trend that may warrant corrective action. In some implementations, the system may employ time-averaged readings or weighted filtering to distinguish between transient thermal spikes and sustained heat buildup, enabling more precise control of the thermal management system 100.

In addition to monitoring the transformer temperature, the controller 170 may also receive temperature data associated with the power source 106, which may correspond to the dark start battery 34 described with respect to FIG. 1. One or more sensors 172 may be positioned within the auxiliary chamber 150, along battery surfaces, terminals, or structural supports that exhibit representative thermal behavior. These sensors may include thermistors, RTDs, or similar elements capable of detecting gradual warming or cooling trends as the system operates. In many implementations, this monitoring function is used to detect cold-start conditions (such as when the power source 106 has been stored in a low-temperature environment) and to determine whether active or passive heating is required before the battery is placed under load. Like the transformer monitoring described above, battery temperature readings may be filtered, averaged, or trend-analyzed.

The controller 170 may also monitor electrical current associated with the NFT 104, particularly along the L1 and L2 conductors that supply downstream loads. For example, one or more current sensors 172 may be installed upstream or downstream of the NFT 104, such as along conductor paths leading to or from the NFT chamber 140. These sensors may include current transformers (CTs), Hall-effect sensors, or shunt-based measurement devices capable of detecting the magnitude and direction of current flow. In some embodiments, separate sensors are used for L1 and L2, allowing the controller 170 to evaluate per-line current levels independently and calculate the degree of load imbalance or asymmetry. Load imbalance may arise when 120V appliances are unevenly distributed across phases, or when particular circuits impose sustained loading on one conductor relative to the other. Over time, such imbalances may contribute to uneven transformer heating or electrical stress. The controller 170 may detect not only the absolute magnitude of transformer loading but also the relative distribution between conductors. In some cases, imbalance may also be inferred indirectly, such as by comparing sensor output at multiple locations or applying algorithmic estimation based on voltage and load feedback.

In some configurations, the controller 170 may also receive voltage-related data from one or more sensors 172 positioned to monitor electrical conditions across or within the NFT 104. These sensors may be coupled to the input and output terminals of the NFT 104 or to associated conductor segments, allowing the system to detect voltage drop, deviation from expected levels (e.g., of 10% or more from nominal line voltage), or the presence of irregular fluctuations. For example, a persistent voltage drop between the input and output of the NFT 104 may indicate elevated internal impedance, degraded winding integrity, or excessive loading. Conversely, voltage spikes or rapid fluctuations may signal transient disturbances, switching anomalies, or other upstream instabilities.

At step 204, the controller 170 enters an evaluation phase in which the monitored data is compared against predefined thresholds, baselines, or logic conditions. These thresholds may be absolute values, such as maximum allowable temperature or current, or they may be relative criteria that reflect dynamic limits, such as a percentage of the NFT's rated current capacity or a differential value between the L1 and L2 conductors. The evaluation logic may be implemented as a set of rule-based instructions, lookup tables, or mathematical models stored in memory and executed by the controller 170 in real time. In some implementations, the evaluation phase accounts for multiple system factors simultaneously. Whether thresholds are crossed by a single measurement or by an aggregated or time-weighted metric, the controller 170 uses these evaluations to determine whether active intervention is warranted.

As part of the evaluation phase, the controller 170 may assess the temperature data associated with the NFT 104 to determine whether thermal thresholds have been exceeded. These thresholds may correspond to fixed absolute values (e.g., 80° C.), dynamic values based on ambient conditions, or user-defined limits reflecting preferred system behavior. If the measured NFT 104 temperature rises above a defined threshold, the controller 170 may classify the condition as requiring active thermal management. Example NFT temperature values may include 80° C. for initial cooling activation, 100° C. for intensified airflow, and 65° C. as a cool-down threshold for reverting to a lower cooling state. In some cases, threshold logic may include multiple temperature bands, such as a caution range, an active cooling trigger, and a critical condition that prompts more aggressive system intervention. The controller 170 may also evaluate the rate of temperature rise or cumulative exposure to elevated temperature to predict emerging stress or potential overheating. If the evaluation confirms that the NFT temperature is outside an acceptable range, the system may proceed to initiate one or more control actions to reduce transformer heat buildup, as described in the operational phase below.

The controller 170 may similarly evaluate temperature data associated with the power source 106 to determine whether active heating or cooling is warranted. In many implementations, the power source 106 includes a battery that may exhibit degraded performance or charging limitations at low temperatures. To address this, the system may define a lower (“cold”) threshold temperature (e.g., 10° C.) below which the battery is considered to require thermal conditioning. If the sensed temperature falls below this threshold, the controller 170 may initiate passive or active heating strategies to elevate the internal temperature of the auxiliary chamber 150. This evaluation may occur at system startup, during periods of inactivity, or after environmental exposure to cold conditions. In some cases, the evaluation may also consider upper temperature thresholds to prevent overtemperature during high-power charge or discharge cycles. Example auxiliary device temperature values may be in the range of approximately 40° C. to approximately 50° C. (e.g., 45° C.) to initiate active cooling via directed airflow.

In addition to absolute current levels, the controller 170 may evaluate the degree of imbalance between the L1 and L2 conductors to assess loading asymmetry across the NFT 104. Such imbalance conditions may arise when one phase supports a disproportionately higher load than the other, leading to uneven thermal stress and potential transformer degradation over time. The system may define an allowable current differential or imbalance threshold, such that if the difference between L1 and L2 currents exceeds this threshold, the controller 170 classifies the condition as requiring corrective action. This evaluation may trigger a targeted airflow response, such as increased cooling airflow across the NFT chamber 140, even if the overall load remains within rated capacity. In one example, preparatory fan activation may occur at 10%, and airflow redirection may be initiated upon a current imbalance exceeding 20%. In some cases, this imbalance threshold may vary based on transformer rating, historical load behavior, or user-defined tolerances.

The controller 170 may also evaluate voltage conditions to detect anomalies that could signal emerging electrical issues within the NFT 104 or associated conductors. For example, persistent voltage drops measured between the input and output terminals of the NFT 104 may indicate elevated winding impedance, internal degradation, or excessive downstream load. Conversely, abrupt voltage spikes could reflect transient faults or instability in the upstream supply. Voltage thresholds may be predefined in absolute terms (e.g., a minimum acceptable output voltage) or relative to expected line conditions (e.g., percentage deviation from nominal values). In some implementations, the controller 170 may track the rate or duration of such deviations to distinguish between brief fluctuations and sustained events warranting intervention. When deviations exceed defined voltage criteria, the system may initiate diagnostic logging, trigger alerts, or apply responsive control actions as appropriate.

In some implementations, the controller 170 may perform compound evaluations that consider multiple parameters in combination, rather than relying solely on independent thresholds. For example, a moderate increase in transformer temperature may not alone justify active cooling, but if accompanied by a substantial current imbalance between conductors L1 and L2, the controller 170 may classify the condition as elevated stress and initiate a responsive action. Similarly, an otherwise acceptable NFT temperature reading may prompt action if the power source 106 is concurrently detected to be below a warming threshold, indicating a scenario where heat should be preserved or redirected. In another scenario, a gradual but consistent rise in temperature over time, paired with a detectable voltage drop across the NFT 104, may indicate cumulative strain not captured by any single instantaneous measurement. These compound analyses may incorporate logic weighting, time-based trends, or rule-based decision structures that allow the controller 170 to prioritize, defer, or modify actions based on the broader operating context.

In scenarios where competing thermal management needs arise, such as concurrent cooling demands from the NFT 104 and heating needs for the power source 106, the controller 170 may implement prioritization logic to resolve how available airflow and control resources are allocated. This logic may rely on predefined hierarchies (e.g., favor cooling over heating), configurable user or installer preferences, or dynamic assessments of system severity. For instance, if the NFT temperature exceeds a high-severity threshold while the power source 106 is only moderately below its warming target, the controller 170 may prioritize airflow through the NFT chamber 140 while temporarily suspending battery heating efforts. Conversely, during system startup in cold climates, battery warming may be prioritized to support expected high-current demand from the HEMS 20, even if NFT temperature is trending upward.

If one or more sensed parameters exceed their corresponding thresholds or are otherwise classified as requiring intervention, the method 200 advances to an operational phase 206 to manage the internal thermal environment of the enclosure 102. In this phase, the controller 170 issues control signals to various components of the thermal management system 100, including the fan 160, the airflow damper 164 at junction 162, and the inlet and outlet valves 124 and 134. These actuated components modify the airflow path 112 through the duct system 110 in accordance with the system's thermal and electrical demands. Depending on the scenario, the response may involve active cooling of the NFT 104, passive or active heating of the power source 106, or redistribution of airflow to accommodate compound or shifting thermal requirements. In some cases, the action phase may also include coordinated sequences in which multiple actuators are adjusted simultaneously or in a timed progression to implement a targeted response strategy.

In response to detected thermal or electrical conditions, the controller 170 may activate the fan 160 to initiate or increase airflow through the enclosure 102. The fan 160 may be configured for variable-speed operation, allowing the controller to modulate airflow rate based on the severity or urgency of the sensed conditions. For example, if the temperature within the NFT chamber 140 exceeds a predefined threshold, the controller 170 may command the fan 160 to operate at a moderate speed, increasing as thermal accumulation continues or if compounding factors such as current imbalance are also detected. In one implementation, the fan speed is governed by a multi-input control algorithm that considers both absolute temperature and the rate of temperature rise, as well as other parameters such as transformer current or voltage anomalies. This dynamic behavior reduces unnecessary energy consumption and noise under light-load or nominal conditions, while allowing responsive and adaptive cooling during periods of elevated thermal demand. The controller may also implement hysteresis logic or time-based holdovers to prevent oscillatory fan behavior around a threshold boundary.

In some embodiments, the fan 160 may be configured for bidirectional or reversible operation, enabling airflow to be actively drawn into or expelled from the enclosure 102. The controller 170 may selectively reverse the fan's direction to accommodate different operational modes, such as purging residual heat following a high-load event or shifting airflow emphasis between intake and exhaust sides of the duct system 110. For example, forward fan operation may pull ambient air 114 through the intake duct 120 and direct it across the NFT chamber 140 and auxiliary chamber 150, whereas reverse operation may expel internal air through the intake vent 122 to reduce internal temperature or humidity. Directional control may also be used in support of passive heating scenarios, wherein the controller 170 disables active airflow in one direction and uses reversed fan pulses to redistribute warmed air within the enclosure 102 without introducing additional cold air. In other configurations, fan direction may be fixed, with airflow routing managed exclusively by valves and dampers.

The airflow damper 164, positioned at the airflow junction 162, directs airflow between the NFT chamber 140 and the auxiliary chamber 150. As previously described, the damper 164 is controllable by the controller 170 and may be moved between at least three discrete positions. In an intermediate position (e.g., FIG. 2), the damper 164 is oriented to permit airflow to pass into both the NFT chamber inlet 142 and the auxiliary chamber inlet 152, allowing simultaneous thermal exchange with both components. In a first redirected position (e.g., FIG. 3), the damper 164 blocks or substantially restricts airflow to the NFT chamber 140 while maintaining an open path to the auxiliary chamber 150, directing the airflow through inlet 152 for dedicated cooling or heating of the power source 106. In a second redirected position (e.g., FIG. 4), the damper 164 blocks airflow to the auxiliary chamber 150 and allows passage into the NFT chamber 140 only, enabling targeted cooling of the NFT 104. These damper positions enable the thermal management system 100 to dynamically allocate airflow based on sensed thermal demand. In some embodiments, the damper 164 may also support continuous or variable positioning, allowing proportional airflow division rather than strictly binary routing.

The thermal management system 100 includes an inlet valve 124 and an outlet valve 134, each controllable by the controller 170 to manage airflow into and out of the enclosure 102. The inlet valve 124, positioned near the inlet vent 122 in the intake duct 120, may be actuated to admit or restrict ambient air 114, while the outlet valve 134, located near the outlet vent 132 in the exhaust duct 130, may be opened to exhaust air or closed to retain heated air. These valves work in coordination with the fan 160 and airflow damper 164 to support various thermal modes, including active cooling (where both valves are open to facilitate airflow across the NFT 104 and/or power source 106) and passive heating, in which both valves are closed to seal the enclosure and allow heat generated by the NFT 104 to accumulate and warm the auxiliary chamber 150. In passive mode, the damper 164 may remain in an intermediate or battery-favoring position, while the fan 160 remains inactive to conserve energy and reduce noise. Valve actuation may be triggered by temperature thresholds, component states, or user-defined routines, and the controller 170 may exit passive mode and re-enable active airflow upon detecting changing conditions or reaching a predefined internal temperature.

Method 200 is configured as a cyclical control routine, in which the completion of an operational response phase naturally leads into renewed monitoring activity. After the controller 170 initiates one or more airflow adjustments (such as activating the fan 160, repositioning the airflow damper 164, or operating inlet and outlet valves 124, 134), it may resume parameter measurement under step 202 to assess the resulting thermal or electrical effects. This continuous evaluation enables adaptive feedback, allowing the system to respond in near real-time to shifting load conditions, environmental changes, or component-specific demands. In some embodiments, the interval between iterations may be fixed, event-driven, or dynamically varied based on observed stability. For example, if conditions return to nominal and remain stable for a predefined duration, the controller 170 may temporarily reduce monitoring frequency to conserve energy. Conversely, if thermal anomalies persist despite corrective action, the system 100 may escalate its response by increasing fan speed, initiating a secondary control mode, or logging a fault event for external review. In this way, method 200 provides an integrated, closed-loop control strategy that continuously governs thermal behavior within the enclosure 102 to preserve performance and maintain operational readiness of both the NFT 104 and the power source 106.

In one example operational scenario, the NFT 104 experiences sustained asymmetric loading, resulting in elevated internal temperatures. Sensors 172 detect a temperature rise within the NFT chamber 140 and identify a current imbalance between conductors L1 and L2, both of which exceed predefined thresholds stored in a memory accessible by the controller 170. In response, the controller 170 initiates a coordinated thermal management routine. First, the fan 160 is activated at a speed determined by the severity of the detected conditions (e.g., higher imbalance and temperature prompting higher fan speed). Concurrently or sequentially, the controller 170 positions the airflow damper 164 at the junction 162 to direct airflow across the NFT chamber 140, while opening the inlet valve 124 and outlet valve 134 to establish an open duct path through the enclosure 102. Ambient air 114 is drawn into the intake duct 120, passed through the NFT chamber 140, and expelled via the exhaust duct 130, allowing accumulated heat to be removed efficiently. Once the NFT temperature begins to normalize and drops below the configured threshold, the controller 170 may scale down fan speed to conserve energy or redirect airflow toward the auxiliary chamber 150 if conditions there warrant heating or cooling. In this way, the thermal management system 100 dynamically transitions between operational states, adjusting component behavior to respond to evolving system demands while maintaining thermal stability across internal components.

In another example operational scenario, the thermal management system 100 may initiate a passive heating mode during cold ambient startup conditions in which the power source 106 (such as a dark start battery) is below its optimal operating temperature. In this case, the controller 170 may determine, based on inputs from one or more sensors 172, that the battery temperature lies beneath a predefined threshold (e.g., 5° C.) and that immediate fan-driven cooling is unnecessary due to the NFT 104 operating under minimal electrical load. Rather than activating the fan 160 or directing airflow, the controller 170 may close the inlet valve 124 and outlet valve 134 to restrict air exchange with the external environment, allowing residual or low-level heat generated by the NFT 104 to accumulate within the enclosure 102. The airflow damper 164 may be set to an intermediate position, thereby enabling thermally conditioned air to migrate passively from the NFT chamber 140 into the auxiliary chamber 150. Over time, this passive heat transfer raises the temperature of the power source 106 without consuming additional energy or generating acoustic output. This enables thermally efficient pre-conditioning of the power source 106 prior to high-demand events such as charging, discharging, or grid reconnection. The controller 170 may continue monitoring the internal conditions and exit the passive mode upon detecting that the power source 106 has reached an acceptable temperature or upon a change in system state that warrants active airflow intervention.

While method 200 is described in the context of the thermal management system 100 shown in FIGS. 2-5, its operation supports the broader home energy system 10 described with respect to FIG. 1. In that configuration, the NFT 104 and power source 106 correspond to transformer 14 and dark start battery 34, respectively, which facilitate grid-independent power delivery and backup functionality. The ability to monitor, evaluate, and control thermal conditions within the shared enclosure 102 ensures that both components remain within desired operating ranges. For example, during an outage scenario in which the dark start battery 34 initiates energization of the HEMS hub 24, method 200 may preemptively warm the battery 34 to increase startup reliability. During normal operation, adaptive cooling of the NFT 14 helps maintain efficiency, extend component life, and reduce stress under imbalanced or elevated loads.

The foregoing description illustrates representative structures, components, and control routines that may be used to implement a thermally managed enclosure for co-located transformer and battery systems. In the context of the home energy system 10 of FIG. 1, the disclosed architecture enables responsive airflow control to address evolving thermal demands across subsystems such as the NFT 14 and dark start battery 34. Although the detailed examples have focused on this paired configuration, the structural and control principles may also support other temperature-sensitive components within the HEMS architecture, including, in some implementations, batteries or power electronics associated with electric vehicles 52 or bidirectional EVSE 50 units. These features may be used independently or in coordination to achieve localized thermal management within the broader home energy environment.

The algorithms, methods, or control routines described herein may be implemented by, or delivered to, one or more processing devices, such as a dedicated electronic controller, programmable control module, or distributed computing architecture. For example, in the context of a home energy system, such processing devices may include a home energy management system (HEMS) controller configured to execute voltage, temperature, or current monitoring logic associated with the neutral-forming transformer (NFT). These algorithms may be embodied as instructions stored on non-transitory machine-readable media, including non-writable storage such as read-only memory (ROM), or writable storage such as random-access memory (RAM), solid-state drives, magnetic media, or optical media. Execution of these instructions may occur through software objects, firmware, or combinations thereof. Alternatively, the disclosed functionality may be implemented, in whole or in part, using suitable hardware structures such as application-specific integrated circuits (ASICs), field-programmable gate arrays (FPGAs), digital state machines, or other logic devices capable of performing control tasks or responding to sensor inputs. In some embodiments, multiple control layers may be distributed across system components and coordinated to monitor operating parameters and execute composite control logic as described herein.

Although illustrative embodiments have been described, the scope of protection afforded by this disclosure is not limited to the specific examples provided. Rather, the embodiments are intended to be illustrative of concepts that may be implemented in various forms consistent with the claims. The terminology used herein is descriptive and not limiting, and structural or functional variations may be made without departing from the general principles set forth. For example, references to a “controller” may include a centralized controller, multiple distributed control modules operating in coordination, or a combination thereof. Control logic described as performed by a single controller may, in some implementations, be divided among multiple devices communicating via wired or wireless connections using established communication protocols.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A thermal management system comprising:
a neutral-forming transformer (NFT) within a duct flow path;
one or more sensors configured to sense a temperature of the NFT and a current imbalance between two electrical conductors coupled to the NFT;
a fan configured to drive airflow through the duct flow path;
a damper disposed within the duct flow path and positionable to direct the airflow; and
a controller configured to, based on the temperature or the current imbalance, adjust a speed of the fan and adjust a position of the damper to direct the airflow toward the NFT in a first position and inhibit the airflow to the NFT in a second position.

2. The thermal management system of claim 1, wherein the controller is configured to adjust the speed according to a plurality of speed levels based on the temperature or the current imbalance.

3. The thermal management system of claim 1, wherein the controller is configured to adjust the speed when both the temperature and the current imbalance exceed respective values.

4. The thermal management system of claim 1, wherein the controller is configured to adjust the position when both the temperature and the current imbalance exceed respective values.

5. The thermal management system of claim 1, wherein the controller is configured to adjust each of the speed and the position when both the temperature and the current imbalance exceed respective values.

6. The thermal management system of claim 1, wherein the controller is configured to adjust the speed or the position after the temperature falls below a cooling value.

7. The thermal management system of claim 1, wherein the controller is configured to adjust the speed and the position based on a rate of change of the temperature or a rate of change of the current imbalance.

8. The thermal management system of claim 1, wherein the damper is further positionable to an intermediate position in which the airflow is directed toward both the NFT and a second region distinct from the NFT.

9. The thermal management system of claim 8, wherein the second region includes a battery and wherein the one or more sensors are configured to sense a battery temperature associated with the battery.

10. The thermal management system of claim 8, wherein with the damper positioned at the intermediate position, the controller is configured to close an inlet valve and an outlet valve when a temperature of a power source within the second region is below a value.

11. A ventilation system for directing airflow across a neutral-forming transformer (NFT), the ventilation system comprising:
a housing including an airflow network having an intake duct, an exhaust duct, a first chamber configured to house the NFT, a second chamber separate from the first chamber, and a junction fluidly coupling the intake duct to the first and second chambers;
a fan configured to drive airflow within the airflow network;
a damper at the junction and movable among a first position in which airflow is directed to both the first chamber and the second chamber, a second position in which airflow is restricted from entering the first chamber, and a third position in which airflow is restricted from entering the second chamber; and
a controller configured to operate the fan and adjust a position of the damper based on a thermal condition associated with the first chamber.

12. The ventilation system of claim 11, wherein the fan is disposed within the intake duct between the junction and an inlet of the airflow network.

13. The ventilation system of claim 11, wherein the fan comprises a variable-speed motor configured to operate in both forward and reverse directions to drive airflow through the airflow network at an adjustable flow rate.

14. The ventilation system of claim 11, further comprising an inlet valve and an outlet valve each movable between an open position and a closed position to control airflow into and out of the housing, wherein the controller is configured to operate the inlet valve and the outlet valve in coordination with operation of the fan and adjustment of the position.

15. The ventilation system of claim 11, further comprising one or more temperature sensors disposed within the first chamber, wherein the controller is configured to operate the fan and adjust the position of the damper based on input from the one or more temperature sensors.

16. A method of operating a thermal management system that includes a duct path across a neutral-forming transformer (NFT) and an auxiliary device, the method comprising:
operating a fan to drive airflow through the duct path;
adjusting a position of a damper disposed within the duct path to direct the airflow toward the NFT when an NFT temperature associated with the NFT exceeds an NFT temperature value or an NFT current imbalance associated with the NFT exceeds an imbalance value; and
adjusting the position of the damper to direct the airflow toward the auxiliary device and away from the NFT when the NFT temperature does not exceed the NFT temperature value, the NFT current imbalance does not exceed the imbalance value, and an auxiliary temperature associated with the auxiliary device exceeds an auxiliary temperature value.

17. The method of claim 16, further comprising:
adjusting the position of the damper to direct airflow to the NFT and the auxiliary device when both the NFT temperature and the auxiliary temperature exceed their respective temperature values.

18. The method of claim 16, further comprising:
positioning the damper to block airflow to the auxiliary device and direct airflow to the NFT when the NFT temperature exceeds the NFT temperature value and the NFT current imbalance exceeds the imbalance value.

19. The method of claim 16, further comprising:
operating the fan and adjusting the position of the damper according to one of a plurality of coordinated airflow responses, wherein each coordinated airflow response corresponds to a combination of the NFT temperature and the NFT current imbalance, and defines a fan speed and a damper position.

20. The method of claim 16, further comprising:
when the auxiliary temperature is below a cold temperature value, closing an inlet valve and an outlet valve of the duct path and deactivating the fan.
